(19) United States
(12) Patent Application Publication
(10) Pub. No.: US 2021/0034806 A1
(43) Pub. Date: Feb. 4, 2021

(54) METHOD, COMPUTER READABLE MEDIUM AND SYSTEM FOR SEMI-AUTOMATED DESIGN OF INTEGRATED CIRCUIT

(71) Applicant: Xiamen Sigmastar Technology Ltd., Xiamen (CN)

(72) Inventor: Hsian-Feng Liu, Taichung City (TW)

(21) Appl. No.: 16/937,617

(22) Filed: Jul. 24, 2020

(30) Foreign Application Priority Data
Jul. 29, 2019 (CN) 201910689087.0

(51) Int. Cl. G06F 30/392; H03L 7/089; H03L 7/099

(52) U.S. Cl. CPC G06F 30/392; G06F 2111/20; H03L 7/099; H03L 7/0891

(57) ABSTRACT

A method, a computer readable medium and a system for a semi-automated design of an integrated circuit are provided, wherein the integrated circuit includes a first partial circuit and a second partial circuit. The method includes: directly using a set of predetermined circuit information that is designed in advance to act as circuit information of the first partial circuit; and generating circuit information of the second partial circuit through an automated design procedure.

### BACKGROUND OF THE INVENTION

### 1. Field of the Invention

The present invention is related to integrated circuit design, and more particularly, to a method, a computer readable medium and a system (e.g. a semi-automated design system) for a semi-automated design of an integrated circuit

### 2. Description of the Prior Art

Designing a high performance integrated circuit (IC) typically needs to spend time on optimizing one or more circuit blocks therein in order to reduce costs. Related art begins to apply an automated design to circuits that used to be manually designed by an engineer, e.g. a phase-locked loop. Currently disclosed automated design procedure of the related art has some disadvantages, however. For example, there are too many variables in the automated design procedure to make the result converge in practice. Thus, there is a need for a novel circuit design method, a computer program product and an associated system, to apply the automated design to a design flow of the high performance IC.

### SUMMARY OF THE INVENTION

Thus, an objective of the present invention provides a method, a computer readable medium and a system (e.g. a semi-automated design system) for a semi-automated design of an integrated circuit (IC), to apply an automated design to a design procedure of the IC in order to reduce time for designing the IC without introducing any side effect or in a way that is less likely to introduce side effects.

At least one embodiment of the present invention provides a method for a semi-automated design of an IC, wherein the IC comprises a first partial circuit and a second partial circuit. The method comprises: directly using a set of predetermined circuit information that is designed in advance to act as circuit information of the first partial circuit; and generating circuit information of the second partial circuit through an automated design procedure.

At least one embodiment of the present invention provides a semi-automated design system for an IC, wherein the IC comprises a first partial circuit and a second partial circuit. The semi-automated design system comprises a storage system and a processing circuit coupled to the storage system, wherein the storage system may be configured to store required data for a semi-automated design procedure and a program code corresponding to the semi-automated design procedure, and the processing circuit may be configured to execute the program code to control the semi-automated design system to perform the semi-automated design procedure. More particularly, the semi-automated design system may directly use a set of predetermined circuit information that is designed in advance to act as circuit information of the first partial circuit, and the semi-automated design system may generate circuit information of the second partial circuit through an automated design procedure.

At least one embodiment of the present invention provides a method for a semi-automated design of a phase-locked loop, wherein the phase-locked loop comprises a phase frequency detector, a charge pump, a loop filter, a voltage controlled oscillator and a frequency divider. The method comprises: directly using a set of predetermined circuit information that is designed in advance to act as circuit information of the phase frequency detector, the charge pump and the frequency divider; and generating circuit information of the voltage controlled oscillator and the loop filter through an automated design procedure.

At least one embodiment of the present invention provides a computer readable medium for a semi-automated design of an IC, wherein the computer readable medium stores a program code corresponding to the semi-automated design procedure, and the program code is capable of being loaded into a computer in order to execute following operations: directly using a set of predetermined circuit information that is designed in advance to act as circuit information of the first partial circuit; and generating circuit information of the second partial circuit through an automated design procedure.

The method (e.g. a semi-automated design method), the computer readable medium storing the program code, and the semi-automated design system provided by embodiments of the present invention can perform an automated design upon only a portion of an IC, making variables within a circuit design procedure can be properly managed. As a result, time for designing a circuit through the automated design can be greatly reduced, and other portions of the IC will not introduce additional variables to cause the problem of implementation difficulties of the automated design. Thus, the present invention can solve the problem of the related art without introducing any side effect or in a way that is less likely to introduce side effects.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a semi-automated design system according to an embodiment of the present invention.

FIG. 2 is a diagram illustrating an integrated circuit (IC) according to an embodiment of the present invention.

FIG. 3 is a working flow of a method for a semi-automated design of an IC according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

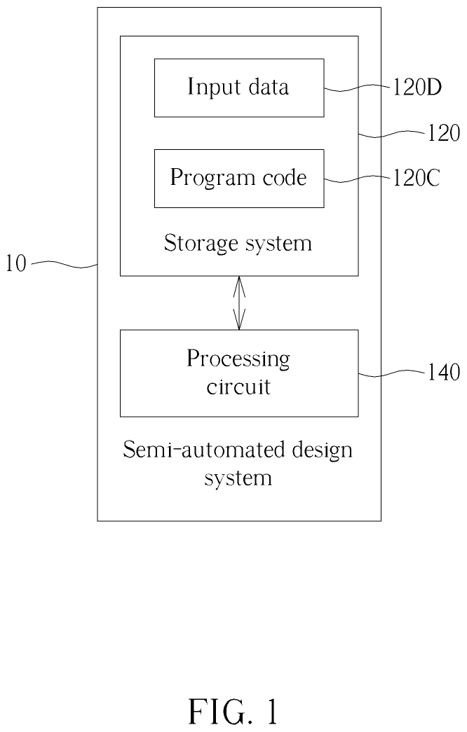

FIG. 1 is a diagram illustrating a semi-automated design system 10 according to an embodiment of the present invention. The semi-automated design system 10 may be configured for a semi-automated design of an integrated circuit (IC). In this embodiment, the semi-automated design system 10 may comprise a storage system 120 and a processing circuit 140 coupled to the storage system 120, where the storage system 120 may be configured to store required data such as input data 120D for a semi-automated design procedure and a semi-automated design computer program product such as a program code 120C corresponding to the semi-automated design procedure, and the processing circuit 140 may be configured to execute the program code 120C to control the semi-automated design system 10 to perform the semi-automated design procedure to perform the semi-automated design of the IC. Examples of the semi-automated design system 10 may include, but are not limited to: a personal computer, a server or any electronic system that is able to execute the semi-automated design procedure, where the processing circuit 140 may be a processor, and the storage system 120 may be a volatile memory or a non-volatile memory.

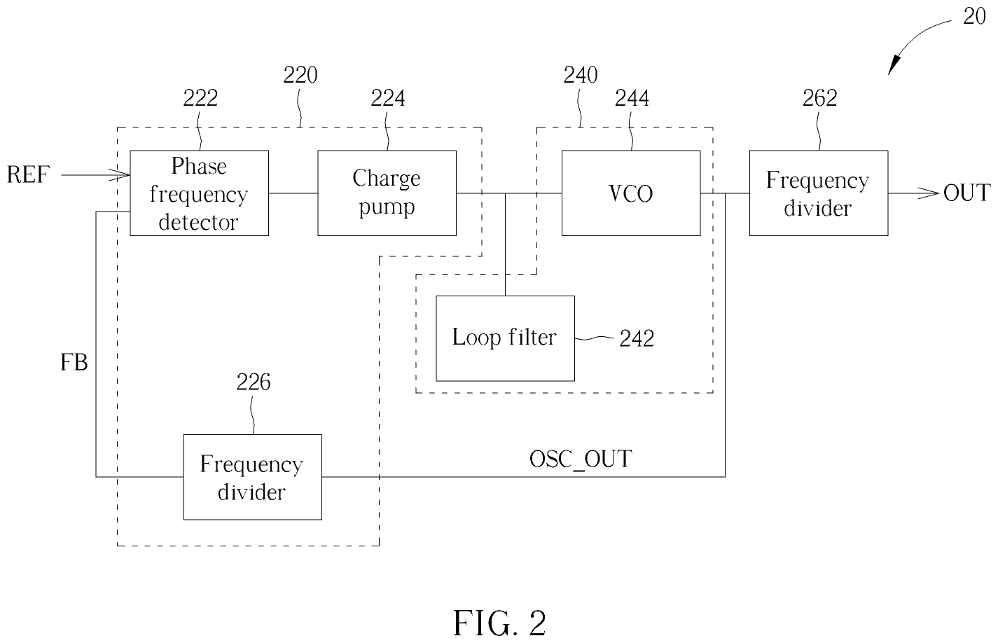

Refer to FIG. 2 in conjunction with FIG. 1. FIG. 2 is a diagram illustrating an IC 20 according to an embodiment of the present invention. The IC 20 may be a phase-locked loop, where the IC 20 may comprise a first partial circuit 220 and a second partial circuit 240. In this embodiment, the first partial circuit 220 may comprise a phase frequency detector 222, a charge pump 224 (e.g. a programmable charge pump) and/or a frequency divider 226 (e.g. a programmable frequency divider), and the second partial circuit 240 may comprise a loop filter 242 and/or a voltage controlled oscillator (VCO) 244. In this embodiment, the charge pump 224 is coupled to the phase frequency detector 222, the loop filter 242 and the VCO 244 are both coupled to the charge pump 224, an output terminal of the VCO 244 is coupled to an input terminal of the frequency divider 226, and an output terminal of the frequency divider 226 is coupled to an input terminal of the phase frequency detector 222. When the phase-locked loop is in operation, the phase frequency detector may receive a reference clock signal REF and a feedback signal FB (which is generated by performing frequency division upon an oscillation output signal OSC_OUT of the VCO 244) from the frequency divider 226, and a frequency divider 262 that is coupled to the output terminal of the VCO 244 may perform frequency division upon the oscillation output signal OSC_OUT of the VCO 244 to generate an output clock signal, to be a clock signal for subsequent circuit operations. Since those skilled in the art of phase-locked loop design may understand operation details of the IC 20 according to the circuit architecture shown in FIG. 2, further description is therefore omitted for brevity. Note that the frequency divider 262 is an optional component. For example, in other applications, the IC 20 may be modified to omit the frequency divider 262.

In the semi-automated design procedure of the IC 20, the semi-automated design system 10 may directly use predetermined circuit information that is designed in advance to act as circuit information of the first partial circuit 220. For example, the input data 120D may comprise circuit information of the phase frequency detector 222, the charge pump 224 and the frequency divider 226, so the semi-automated design system 10 does not need to spend additional time costs for automated designs of the phase frequency detector 222, the charge pump 224 and the frequency divider 226 in a subsequent flow. In some embodiments, one or more sub-circuits within the first partial circuit 220 may be implemented by programmable circuits, such as a programmable charge pump and/or a programmable frequency divider, but the present invention is not limited thereto. In addition, the semi-automated design system 10 may generate circuit information of the second partial circuit 240 through an automated design procedure. For example, the second partial circuit 240 may comprise a first sub-circuit (e.g. the VCO 244) and a second sub-circuit (e.g. the loop filter 242), and the automated design procedure may comprise a first automated design sub-procedure and a second automated design sub-procedure, where the semi-automated design system 10 may generate circuit information of the VCO 244 (e.g. sizes of respective transistors within the VCO 244 or a gain of the VCO 244) through the first automated design sub-procedure first, and then generate circuit information of the loop filter 242 according to the circuit information of the VCO 244 (e.g. obtain respective parameters of the loop filter 242 such as resistances and capacitances therein via mathematical calculations) through the second automated design sub-procedure. For example, the automated design procedure (e.g. the first automated design sub-procedure and/or the second automated design sub-procedure) may be implemented by the method disclosed in Documents of U.S. Pat. Nos. 6,260,176 and 7,304,544, which are included herein by reference. In this embodiment, the first automated design sub-procedure configured to generate the circuit information of the VCO 244 is not limited to a specific type of automated design method. Those can automatically complete a design of a VCO via a computer or a server without manual operations of an engineer are applicable to the aforementioned first automated design sub-procedure, and related details are omitted for brevity.

In addition, the aforementioned semi-automated design procedure may further comprise arranging a layout of the IC 20. Before generating the circuit information of the second partial circuit 240 (e.g. the circuit information of the VCO 244 and the circuit information of the loop filter 242), the semi-automated design system 10 may arrange layouts of the first partial circuit 220 and the second partial circuit 240 in a physical chip in advance. As the circuit information of the second partial circuit 240 (e.g. sizes of transistors therein) is generated by an automated design procedure, a required layout space for the second partial circuit 140 in the physical chip has not been decided yet before the automated design procedure is initiated. In order to guarantee that a layout region for the second partial circuit 240 is applicable to the circuit information (e.g. the circuit information generated by the automated design procedure) of the second partial circuit 240, the layout region arranged for the second partial circuit 240 in the physical chip may comprise a reserved space, so the layout region can allow the second partial circuit 240 to be designed with multiple different transistor sizes. More particularly, a first layout region arranged for the VCO 244 in the physical chip by the semi-automated design system 10 may comprise a first reserved space, to guarantee that the first layout region is applicable to the circuit information of the VCO 244 (e.g. sizes of transistors therein); and a second layout region arranged for the loop filter 242 in the physical chip by the semi-automated design system 10 may comprise a second reserved space, to guarantee that the second layout region is applicable to the circuit information of the loop filter 242 (e.g. sizes of transistors therein).

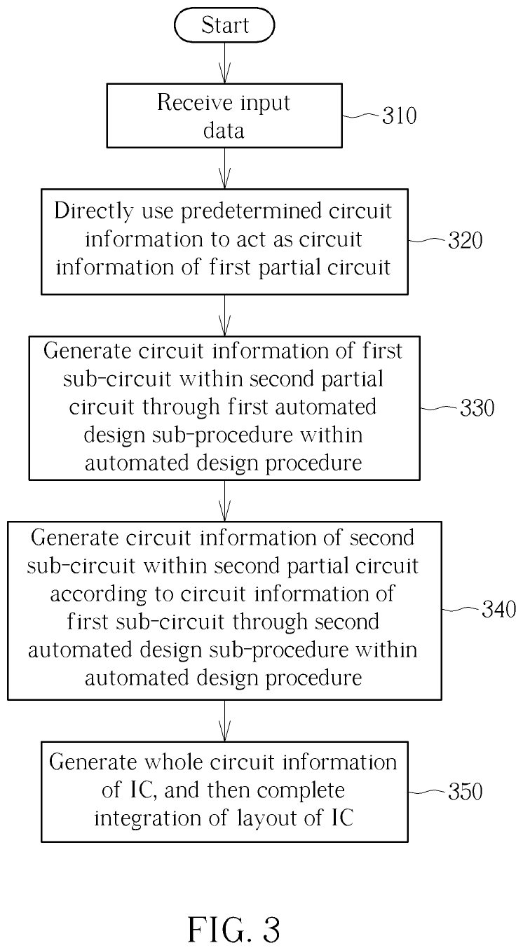

For better comprehension of a semi-automated design method of the present invention, please refer to FIG. 3 in conjunction with FIG. 1 and FIG. 2. FIG. 3 is a working flow of a method (e.g. the semi-automated design method) for a semi-automated design of an IC (e.g. the IC 20) according to an embodiment of the present invention. It should be noted that the working flow shown in FIG. 3 is for illustrative purposes only, but is not a limitation of the present invention. One or more steps may be added, deleted or modified in the working flow shown in FIG. 3. In addition, if a same result may be obtained, these steps do not have to be executed in the exact order shown in FIG. 3.

In Step 310, the semi-automated design system 10 may receive the input data 120D from outside, and store the input data 120D in the storage system 120. The input data 120D may comprise predetermined circuit information (e.g. circuit description files and layout files of the phase frequency detector 222, the charge pump 224, the frequency divider 226 and other circuit blocks) that is designed in advance, and may further comprise all required data for performing the automated design of the second partial circuit 240, such as a criteria file recording target specification(s) of the second partial circuit 240.

In Step 320, the semi-automated design system 10 may directly use the predetermined circuit information to act as circuit information of the first partial circuit 220 (such as the phase frequency detector 222, the charge pump 224 and the frequency divider 226 therein). Thus, in the following steps, the semi-automated design system 10 does not need to spend additional time costs to design the phase frequency detector 222, the charge pump 224 and the frequency divider 226.

In Step 330, the semi-automated design system 10 may generate circuit information (e.g. a circuit description file (which includes sizes of transistors within the VOC 244 and/or a gain of the VCO 244) and/or a corresponding layout file) of a first sub-circuit (e.g. the VCO 244) within the second partial circuit 240 through a first automated design sub-procedure within an automated design procedure.

In Step 340, the semi-automated design system 10 may generate circuit information (e.g. a circuit description file (which includes one or more parameters such as capacitances and resistances within the loop filter 242) and/or a corresponding layout file) of a second sub-circuit (e.g. the loop filter 242) within the second partial circuit 240 according to the circuit information of the first sub-circuit (e.g. the gain of the VCO 244) through a second automated design sub-procedure within the automated design procedure.

In Step 350, the semi-automated design system 10 may generate whole circuit information of the IC 20 according to all circuit information (e.g. the predetermined circuit information, the circuit information of the VCO 244 and the circuit information of the loop filter 242) generated in the above steps, and then complete integration of layout of the IC 20.

To summarize, the method and the system (e.g. the semi-automated design system 10) for a semi-automated design of an IC can divide the IC into two portions, where one portion directly uses circuit information that is designed in advance or existing circuit information, and circuit information of another portion is generated by an automated design procedure. As the IC is not completely designed by an automated design procedure, the semi-automated design procedure of the present invention (one portion is predetermined circuit information that is designed in advance or existing circuit information, and another portion is generated by the automated design procedure (e.g. the system execute corresponding operations according to program commands without additional human work, i.e., the automated design procedure operates without user intervention) can reduce variables that need to be considered during the automated design procedure in comparison with full-automated design procedure of the related art.

Note that a phase-locked loop design in the above embodiments is merely an example of the semi-automated design procedure disclosed in the present invention. The present invention is not limited thereto. Any integrated circuit (which includes one partial circuit that is designed in advance and another partial circuit that is designed by an automated design procedure) that is designed by the semi-automated design procedure disclosed in the present invention belongs to the scope of the present invention. In addition, the architecture of the phase-locked loop shown in FIG. 2 is for illustrative purposes only. In practice, the semi-automated design procedure disclosed in the present invention may be applicable to other phase-locked loop architecture, and these alternative designs also belong to the scope of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for a semi-automated design of an integrated circuit, the integrated circuit comprising a first partial circuit and a second partial circuit, the method comprising:
directly using a set of predetermined circuit information that is designed in advance to act as circuit information of the first partial circuit; and
generating circuit information of the second partial circuit through an automated design procedure.

2. The method of claim 1, wherein the second partial circuit comprises a first sub-circuit and a second sub-circuit, the automated design procedure comprises a first automated design sub-procedure and a second automated design sub-procedure, and the step of generating the circuit information of the second partial circuit through the automated design procedure comprises:
generating circuit information of the first sub-circuit through the first automated design sub-procedure; and
generating circuit information of the second sub-circuit according to the circuit information of the first sub-circuit through the second automated design sub-procedure.

3. The method of claim 2, wherein the integrated circuit is a phase-locked loop.

4. The method of claim 3, wherein the first partial circuit comprises a phase frequency detector, a charge pump or a frequency divider.

5. The method of claim 1, wherein the second partial circuit comprises a voltage controlled oscillator.

6. The method of claim 5, wherein the circuit information of the second partial circuit comprises a gain of the voltage controlled oscillator.

7. The method of claim 1, wherein the second partial circuit comprises a loop filter.

8. The method of claim 1, further comprising:
before generating the circuit information of the second partial circuit, arranging layouts of the first partial circuit and the second partial circuit in a physical chip in advance, wherein a layout region arranged for the second partial circuit in the physical chip comprises a reserved space to guarantee that the layout region is applicable to the circuit information of the second partial circuit.

9. A semi-automated design system for an integrated circuit, the integrated circuit comprising a first partial circuit and a second partial circuit, the semi-automated design system comprising:
a storage system, configured to store required data for a semi-automated design procedure and a program code corresponding to the semi-automated design procedure; and
a processing circuit, coupled to the storage system and configured to execute the program code to control the semi-automated design system to perform the semi-automated design procedure, wherein:
the semi-automated design system directly uses a set of predetermined circuit information that is designed in advance to act as circuit information of the first partial circuit; and
the semi-automated design system generates circuit information of the second partial circuit through an automated design procedure.

10. The semi-automated design system of claim 9, wherein the second partial circuit comprises a first sub-circuit and a second sub-circuit, the automated design procedure comprises a first automated design sub-procedure and a second automated design sub-procedure, and operations of the semi-automated design system in the automated design procedure comprise:
generating, by the semi-automated design system, circuit information of the first sub-circuit through the first automated design sub-procedure; and
generating, by the semi-automated design system, circuit information of the second sub-circuit according to the circuit information of the first sub-circuit through the second automated design sub-procedure.

11. The semi-automated design system of claim 9, wherein the integrated circuit is a phase-locked loop.

12. The semi-automated design system of claim 11, wherein the first partial circuit comprises a phase frequency detector, a charge pump or a frequency divider.

13. The semi-automated design system of claim 9, wherein the second partial circuit comprises a voltage controlled oscillator.

14. The semi-automated design system of claim 13, wherein the circuit information of the second partial circuit comprises a gain of the voltage controlled oscillator.

15. The semi-automated design system of claim 9, wherein the second partial circuit comprises a loop filter.

16. The semi-automated design system of claim 1, wherein:
before generating the circuit information of the second partial circuit, the semi-automated design system arranges layouts of the first partial circuit and the second partial circuit in a physical chip in advance, wherein a layout region arranged for the second partial circuit in the physical chip comprises a reserved space to guarantee that the layout region is applicable to the circuit information of the second partial circuit.

17. A method for a semi-automated design of a phase-locked loop, the phase-locked loop comprising a phase frequency detector, a charge pump, a loop filter, a voltage controlled oscillator and a frequency divider, the method comprising:
directly using a set of predetermined circuit information that is designed in advance to act as circuit information of the phase frequency detector, the charge pump and the frequency divider; and
generating circuit information of the voltage controlled oscillator and the loop filter through an automated design procedure.

18. The method of claim 17, wherein the step of generating the circuit information of the voltage controlled oscillator and the loop filter through the automated design procedure comprises:
generating the circuit information of the voltage controlled oscillator through a first automated design sub-procedure within the automated design procedure; and
generating the circuit information of the loop filter according to the circuit information of the voltage controlled oscillator through a second automated design sub-procedure within the automated design procedure.

19. The method of claim 18, wherein the circuit information of the voltage controlled oscillator comprises a gain of the voltage controlled oscillator.

20. The method of claim 17, further comprising:
before generating the circuit information of the voltage controlled oscillator and the circuit information of the loop filter, arranging layouts of the phase frequency detector, the charge pump, the loop filter, the voltage controlled oscillator and the frequency divider in a physical chip in advance, wherein:
a first layout region arranged for the voltage controlled oscillator in the physical chip comprises a first reserved space to guarantee that the first layout region is applicable to the circuit information of the voltage controlled oscillator; and
a second layout region arranged for the loop filter in the physical chip comprises a second reserved space to guarantee that the second layout region is applicable to the circuit information of the loop filter.

21. A computer readable medium for a semi-automated design of an integrated circuit, wherein the computer readable medium stores a program code corresponding to the semi-automated design procedure, and the program code is capable of being loaded into a computer in order to execute following operations:
directly using a set of predetermined circuit information that is designed in advance to act as circuit information of the first partial circuit; and
generating circuit information of the second partial circuit through an automated design procedure.

22. The computer readable medium of claim 21, wherein the second partial circuit comprises a first sub-circuit and a second sub-circuit, the automated design procedure comprises a first automated design sub-procedure and a second automated design sub-procedure, and the operation of generating the circuit information of the second partial circuit through the automated design procedure comprises:
generating circuit information of the first sub-circuit through the first automated design sub-procedure; and
generating circuit information of the second sub-circuit according to the circuit information of the first sub-circuit through the second automated design sub-procedure.

23. The computer readable medium of claim 22, wherein the integrated circuit is a phase-locked loop.

24. The computer readable medium of claim 23, wherein the first partial circuit comprises a phase frequency detector, a charge pump or a frequency divider.

25. The computer readable medium of claim 21, wherein the second partial circuit comprises a voltage controlled oscillator.

26. The computer readable medium of claim 25, wherein the circuit information of the second partial circuit comprises a gain of the voltage controlled oscillator.

27. The computer readable medium of claim 21, wherein the second partial circuit comprises a loop filter.

28. The computer readable medium of claim 21, wherein the operations further comprise:
before generating the circuit information of the second partial circuit, arranging layouts of the first partial circuit and the second partial circuit in a physical chip in advance, wherein a layout region arranged for the second partial circuit in the physical chip comprises a reserved space to guarantee that the layout region is applicable to the circuit information of the second partial circuit.
